(19) United States
(12) Patent Application Publication
(10) Pub. No.: US 2010/0170142 A1
(43) Pub. Date: Jul. 8, 2010

(54) Use of Proteins as Demulsifying Agents

(75) Inventors: Dietmar Posselt, Heidelberg (DE); Werner Schmitt, Schönau (DE); Marcus Guzmann, Mühlhausen (DE); Claudius Kormann, Schifferstadt (DE); Matthias Kiefer, Ludwigshafen (DE); Claus Bollschweiler, Heidelberg (DE); Thomas Subkowski, Ladenburg (DE); Hans-Georg Lemaire, Limburgerhof (DE); Marvin Karos, Schwetzingen (DE); Ulf Baus, Dossenheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/886,610

(22) PCT Filed: Mar. 29, 2006
(86) PCT No.: PCT/EP2006/061132

§ 371 Date: May 27, 2009

(30) Foreign Application Priority Data
Apr. 1, 2005 (EP) 05007208.1
Aug. 4, 2005 (EP) 05016962.2

(51) Int. Cl. B01D 17/04; C10L 1/32; C08F 2/32; C10L 1/04

(52) U.S. Cl. 44/301; 210/749; 524/801; 208/16

(57) ABSTRACT

The present invention relates to the use of at least one protein, in particular at least one hydrophobin or at least one derivative thereof, for improving phase separation in compositions comprising at least two liquid phases, to methods for separating at least two liquid phases in a composition comprising at least two liquid phases, and to formulations comprising at least one compound selected from the group consisting of fuels, combustibles, crude oils or water-soluble or oil-soluble polymer solutions and at least one protein, in particular at least one hydrophobin or derivatives thereof.

The present invention relates to the use of at least one hydrophobin or at least one derivative thereof, for improving phase separation in compositions comprising at least two liquid phases, to methods for separating at least two liquid phases in a composition comprising at least two liquid phases, and to formulations comprising at least one compound selected from the group consisting of fuels, combustibles, crude oils or water-soluble or oil-soluble polymer solutions and at least one hydrophobin or derivatives thereof.

Hydrophobins are small proteins of from about 100 to 150 amino acids and which are characteristic for filamentous fungi, for example Schizophillum commune. As a rule, they possess 8 cysteine units.

Hydrophobins exhibit a marked affinity for interfaces and are therefore suitable for coating surfaces in order to alter the properties of the interfaces by forming amphipathic membranes. Thus, Teflon, for example, can be coated with hydrophobins, thereby obtaining a hydrophilic surface.

Hydrophobins can be isolated from natural sources. Methods for preparing hydrophobins, and derivatives thereof, are also known. For example, DE 10 2005 007 480.4 discloses a method for preparing hydrophobins and their derivatives.

The prior art proposes using hydrophobins for a variety of applications.

WO 96/41882 proposes using hydrophobins as emulsifiers, thickeners or surface-active substances for hydrophilizing hydrophobic surfaces, for improving the water resistance of hydrophilic substrates or for preparing oil-in-water emulsions or water-in-oil emulsions. The document also proposes pharmaceutical applications, such as the preparation of ointments or creams, and also cosmetic applications, such as skin protection or the preparation of hair shampoos or hair rinses. In addition to this, WO 96/41882 claims compositions, in particular compositions for pharmaceutical applications, which comprise hydrophobins.

EP-A 1 252 516 discloses the coating of windows, contact lenses, biosensors, medical devices, receptacles for implementing experiments or for storage, ship holds, solid particles or frames or passenger car bodies with a solution comprising hydrophobins at a temperature of from 30 to 80° C.

WO 03/53383 discloses the use of hydrophobins for treating keratin materials in cosmetic applications.

WO 03/10331 discloses that hydrophobins exhibit surface-active properties. Thus, the document discloses a sensor, for example a measuring electrode, which is coated with hydrophobin and to which other substances, e.g. electroactive substances, antibodies or enzymes, are bound noncovalently.

WO 2004/000880 also discloses the coating of surfaces with hydrophobin or hydrophobin-like substances. It is furthermore disclosed that oil-in-water or water-in-oil emulsions can also be stabilized by adding hydrophobins.

WO 01/74864, which relates to hydrophobin-like proteins, also discloses that these proteins can be used for stabilizing dispersions and emulsions.

It is in principle known to use proteins for phase separation.

GB 195,876 discloses a method for breaking water-in-oil emulsions using colloids. The colloids which are mentioned by way of example are proteins such as gelatin, casein and albumin, or polysaccharides such as gum arabic or gum tragacanth.

JP-A 11-169177 discloses the use of proteins possessing lipase activity for breaking emulsions.

WO 06/60916 discloses the use of surfactant-free mixtures, composed of at least one water-soluble protein, at least one water-soluble polysaccharide and at least one water-soluble polymer such as polyethylene oxide, for different applications which also include demulsifying crude oil.

None of the cited documents discloses the use of hydrophobines for phase separation.

The use of proteins has the advantage that they are substances which also occur naturally and are biologically degradable and consequently do not lead to any permanent pollution of the environment.

In the case of many large-scale industrial applications, for example when separating crude oil-water emulsions, it is important for the phases to be separated as rapidly as possible. The object of the invention was to provide an improved method for phase separation using proteins.

According to the invention, this object is achieved by using at least one hydrophobin for improving phase separation in compositions which comprise at least two liquid phases.

In this connection, the hydrophobin can, in principle, in accordance with the invention, be employed in any arbitrary quantity as long as this ensures that the phase separation in the compositions comprising at least two liquid phases, is improved.

Within the context of the present invention, “improving the phase separation” is understood as meaning that the separation of two liquid phases when a substance is added to a mixture takes place more rapidly than in the same mixture without the addition of the substance, or that the separation of two liquid phases is only made possible by adding the substance.

Within the context of the present invention, a hydrophobin is also understood as being derivatives thereof or modified hydrophobin. Modified or derivatized hydrophobins can, for example, be hydrophobin-fusion proteins or proteins which have an amino acid sequence which exhibit at least 60%, for example at least 70%, in particular at least 80%, particularly preferably at least 90%, in particular preferably at least 95%, identity with the sequence of a hydrophobin and which also fulfill the biological properties of a hydrophobin to an extent of 50%, for example to an extent of 60%, in particular to an extent of 70%, particularly preferably to an extent of 80%, in particular the property that the surface properties are altered by coating with these proteins such that the contact angle of a water drop before and after the coating of a glass surface with the protein is increased by at least 20°, preferably by at least 25°, in particular by at least 30°.

It has been found, surprisingly, that hydrophobins or derivatives thereof improve the separation of at least two liquid phases.

This is particularly advantageous when rapid phase separation is to be achieved or the occurrence of emulsions is to be prevented. Even small quantities are extremely effective in this connection. This property can likewise be used when already existing emulsions are to be broken up. Compounds which break up emulsions are also termed demulsifiers.

The present invention therefore also relates to a use, as described above, of at least one hydrophobin or at least one derivative thereof, with the at least one hydrophobin or at least one derivative thereof being employed as a demulsifier.

In this connection, the structural specificity, and not the sequence specificity, of the hydrophobins is of decisive importance for defining hydrophobins. While the amino acid sequences of the natural hydrophobins are very diverse, they all have a highly characteristic pattern of 8 conserved cysteine residues. These residues form four intramolecular disulfide bridges.

The N terminus and the C terminus are variable over a relatively wide range. Fusion partner proteins having a length of from 10 to 500 amino acids and found, for example, in accordance with molecular biological techniques which are known to the skilled person, can be added at these termini.

In addition to this, proteins having a similar structure and functional equivalence are to be understood as being hydrophobins and derivatives thereof within the meaning of the present invention.

Within the meaning of the present invention, the term “hydrophobins” is to be understood as referring, in that which follows, to polypeptides of the general structural formula (I)

Xₙ—C¹—X₁₋₅₀—C²—X₀₋₅—C³—X₁₋₁₀₀—C⁴—X₁₋₁₀₀—C⁵—X₁₋₅₀—C⁶—X₀₋₅—C⁷—X₁₋₅₀—C⁸—Xₘ (I)

where X can be any of the 20 naturally occurring amino acids (Phe, Leu, Ser, Tyr, Cys, Trp, Pro, His, Gln, Arg, Ile Met, Thr, Asn, Lys, Val, Ala, Asp, Glu and Gly). X can here in each case be identical or different. In the formula, the indices at X are in each case the number of amino acids, C is cysteine, alanine, serine, glycine, methionine or threonine, at least four of the radicals designated C being cysteine, and the indices n and m are, independent of each other for natural numbers between 0 and 500, preferably between 15 and 300.

The polypeptides according to the formula (I) are furthermore characterized by the property that, at room temperature, after coating a glass surface, they bring about an increase in the contact angle of a water drop by at least 20°, preferably at least 25° and particularly preferably 30° in each case compared with the contact angle which a water drop of the same size makes with the uncoated glass surface.

The amino acids named C¹ to C⁸ are preferably cysteines; however, they can also be replaced by other amino acids exhibiting similar space filling, preferably by alanine, serine, threonine, methionine or glycine. However, at least four, preferably at least 5, particularly preferably at least 6, and in particular at least 7, of the positions C¹ to C⁸ should comprise cysteines. Cysteines can, in the proteins of the invention, either be present in the reduced state or form disulfide bridges with each other.

Particular preference is given to the intramolecular formation of C—C bridges, in particular that involving at least one, preferably 2, particularly preferably 3, and very particularly preferably 4, intramolecular disulfide bridges. In connection with the above-described replacement of cysteines by amino acids with a similar space filling, the C positions which are able to form intramolecular disulfide bridges with each other are advantageously replaced in pairs.

If cysteines, serines, alanines, glycines, methionines or threonines are also used in the positions designated by X, the numbering of the individual C positions in the general formulae can change correspondingly.

Preference is given to using hydrophobins of the formula (II)

Xₙ—C¹—X₃₋₂₅—C²—X₀₋₂—C³—X₅₋₅₀—C⁴—X₂₋₃₅—C⁵—X₂₋₁₅—C⁸—X₀₋₂—C⁷—X₃₋₃₅—C⁸—Xₘ (II)

where X, C and the indices at X and C have the above meaning, the indices n and m are numbers between 0 and 300, and the proteins are furthermore characterized by the abovementioned contact angle change, for implementing the present invention, with at least 6 of the residues named C also being cysteine. Particular preference is given to all the C residues being cysteine.

Particular preference is given to using hydrophobins of the formula (III)

Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)

where X, C and the indices at X have the above meaning, the indices n and m are numbers between 0 and 200, the proteins are furthermore characterized by the abovementioned contact angle change, and at least 6 of the residues named C are cysteine. Particular preference is given to all the C residues being cysteine.

The residues Xₙ and Xₘ can be peptide sequences which are naturally also linked to a hydrophobin. However, one or both residues can also be peptide sequences which are not naturally linked to a hydrophobin. This is also to be understood as including Xₙ and/or Xₘ residues in which a peptide sequence which naturally occurs in a hydrophobin is extended by a peptide sequence which does not occur naturally in a hydrophobin.

If Xₙ and/or Xₘ are peptide sequences which are not naturally linked in hydrophobins, these sequences are as a rule at least 20, preferably at least 35, particularly preferably at least 50, and very particularly preferably at least 100, amino acids in length. Such a residue, which is not naturally linked to a hydrophobin, will also be termed fusion partner in that which follows. This is thereby intended to express the fact that the proteins can be composed of at least one hydrophobin moiety and a fusion partner moiety which are not found together in this form in nature.

The fusion partner moiety can be selected from a large number of proteins. It is also possible for several fusion partners to be linked to one hydrophobin moiety, for example at the amino terminus (Xₙ) and at the carboxy terminus (Xₘ) of the hydrophobin moiety. However, it is also possible, for example, for two fusion partners to be linked to one position (Xₙ or Xₘ) of the protein according to the invention.

Proteins which naturally occur in microorganisms, in particular in E. coli or Bacillus subtilis, are particularly suitable fusion partners. Examples of these fusion partners are the sequences yaad (SEQ ID NO: 15 and 16), yaae (SEQ ID NO: 17 and 18) and thioredoxin. Fragments or derivatives of these said sequences which only comprise a part, for example from 70 to 99%, preferably from 5 to 50%, and particularly preferably from 10 to 40%, of said sequences, or in which individual amino acids or nucleotides are changed as compared with said sequence, are also very suitable, with the percentage values in each case referring to the number of amino acids.

In another preferred embodiment, the hydrophobin fusion also exhibits, in addition to the fusion partner as a group Xₙ or Xₘ, what is termed an affinity domain (affinity tag/affinity tail). Affinity domains are, in a manner which is known in principle, anchoring groups which are able to interact with given complementary groups and which can be used for simplifying the work-up and purification of the proteins. Examples of such affinity domains include (His)ₖ, (Arg)ₖ, (Asp)ₖ, (Phe)ₖ and (Cys)ₖ groups, with k in general being a natural number of from 1 to 10. The affinity domain can preferably be a (His)ₖ group, where k is from 4 to 6.

The polypeptide sequences of the proteins which are used in accordance with the invention as hydrophobins or derivatives thereof can also be modified, for example by glycosylation or acetylation or else by chemical crosslinking, for example using glutaraldehyde.

One property of the hydrophobins, or derivatives thereof, which are used in accordance with the invention is the change in surface properties when the surfaces are coated with the proteins. The change in the surface properties can be determined experimentally by, for example, measuring the contact angle of a water drop before and after coating the surface with the protein and determining the difference in the two measurements.

Measuring contact angles is known in principle to the skilled person. The measurements are based on room temperature and water drops of 5 μl and the use of glass platelets as substrate. The precise experimental conditions for a method suitable, for example, for measuring the contact angle are described in the experimental section. Under the conditions specified in the experimental section, the fusion proteins which are used in accordance with the invention possess the property of increasing the contact angle by at least 20°, preferably at least 25°, particularly preferably at least 30°, in each case compared with the contact angle which a water drop of the same size makes with the uncoated glass surface.

Hydrophobins which are particularly preferred for implementing the present invention are the hydrophobins of the type dewA, rodA, hypA, hypB, sc3, basf1, basf2, which are characterized structurally in the sequence listing which follows. However, the hydrophobins can also be only parts or derivatives of these hydrophobins. It is also possible for several hydrophobin parts, preferably 2 or 3, of identical or different structure, to be linked to each other and to be linked to a corresponding suitable polypeptide sequence which is not naturally associated with a hydrophobin.

The fusion proteins yaad-Xa-dewA-his (SEQ ID NO: 20), yaad-Xa-rodA-his (SEQ ID NO: 22) or yaad-Xa-basf1-his (SEDQ ID NO: 24) having the polypeptide sequences given in brackets, as well as the nucleic acid sequences encoding them, in particular the sequences depicted in SEQ ID NO: 19, 21 and 23, are also particularly suitable in accordance with the invention. Proteins which are derived from the polypeptide sequences depicted in SEQ ID NO: 20, 22 or 24 by the substitution, insertion or deletion of at least one up to 10, preferably 5, particularly preferably 5% of all the amino acids, and which still possess at least 50% of the biological property of the starting proteins, are also particularly preferred embodiments. In this context, the biological property of the proteins is understood as being the change in the contact angle by at least 20°, as already described.

Derivatives which are particularly suitable for implementing the invention are residues which are derived from yaad-Xa-dewA-his (SEQ ID NO: 20), yaad-Xa-rodA-his (SEQ ID NO: 22) or yaad-Xa-basf1-his (SEQ ID NO: 24) by truncating the yaad fusion partner. Instead of the complete yaad fusion partner (SEQ ID NO: 16) comprising 294 amino acids, it is advantageously possible to use a truncated yaad residue. However, the truncated residue should comprise at least 20, preferably at least 35, amino acids. For example, it is possible to use a truncated residue having from 20 to 293, preferably from 25 to 250, particularly preferably from 35 to 150, and, for example, from 35 to 100, amino acids.

A cleavage site between the hydrophobin and the fusion partner or the fusion partners can be used for releasing the pure hydrophobin in underivatized form (for example by means of BrCN cleavage at methionine, factor Xa cleavage, enterokinase cleavage, thrombin cleavage, TEV cleavage, etc.).

It is furthermore possible to generate fusion proteins from one fusion partner, for example yaad or yaae, and several hydrophobins, including of differing sequence (for example DewA-RodA or Sc3-DewA, or Sc3-RodA) one behind the other. It is likewise possible to use hydrophobin fragments (for example N- or C-terminal truncations) or mutein which exhibit up to 70% homology. The optimal constructs are in each case chosen in relation to the given use, i.e. the liquid phases to be separated.

The hydrophobins used in accordance with the invention, or the hydrophobins present in the formulations according to the invention, can be prepared chemically using known methods of peptide synthesis, for example by means of Merrifield solid phase synthesis.

Naturally occurring hydrophobins can also be isolated from natural sources using suitable methods. The reader is referred, by way of example, to Wösten et. al., Eur. J. Cell Bio. 63, 122-129 (1994) or WO 96/41882.

It is preferentially possible to prepare fusion proteins by means of recombinant methods in which a nucleic acid sequence, in particular DNA sequence, encoding the fusion partner, and one encoding the hydrophobin moiety are combined such that the desired protein is produced in a host organism as a result of the combined nucleic acid sequence being expressed. A preparation method of this nature is disclosed, for example, in DE 102005007480.4.

In this connection, suitable host organisms (production organisms) for said preparation method can be prokaryotes (including the Archaea) or eukaryotes, particularly bacteria including halobacteria and methanococci, fungi, insect cells, plant cells and mammalian cells, particularly preferably Escherichia coli, Bacillus subtilis, Bacillus megaterium, Aspergillus oryzea, Aspergillus nidulans, Aspergillus niger, Pichia pastoris, Pseudomonas spec., lactobacilli, Hansenula polymorpha, Trichoderma reesei, SF9 (or related cells) and others.

The invention also relates to the use of expression constructs which comprise a nucleic acid sequence which encodes a polypeptide which is used in accordance with the invention, under the genetic control of regulatory nucleic acid sequences, and also vectors which comprise at least one of these expression constructs.

Constructs which are employed preferably comprise a promoter 5′ upstream of the given coding sequence and a terminator sequence 3′ downstream as well as, if appropriate, other customary regulatory elements, each of which is operatively linked to the coding sequence.

Within the context of the present invention, “operative linkage” is understood as meaning the sequential arrangement of promoter, coding sequence, terminator and, if appropriate, additional regulatory elements such that each of the regulatory elements can fulfill its function, in accordance with its intended use, in connection with the coding sequence being expressed.

Examples of operatively linkable sequences are targeting sequences as well as enhancers, polyadenylation signals and the like. Other regulatory elements comprise selectable markers, amplification signals, replication origins and the like. Suitable regulatory sequences are described, for example, in Goeddel, Gene Expression Technology: Methods in Enzymology 185, Academic Press, San Diego, Calif. (1990).

In addition to these regulatory sequences, the natural regulation of these sequences can still be present upstream of the actual structural genes and, if appropriate, have been altered genetically such that the natural regulation has been switched off and the expression of the genes has been increased.

A preferred nucleic acid construct also advantageously comprises one or more enhancer sequences which are functionally linked to the promoter and which enable the expression of the nucleic acid sequence to be increased. Additional advantageous sequences, such as further regulatory elements or terminators, can also be inserted at the 3′ end of the DNA sequences.

The nucleic acids can be present in the construct in one or more copies. It is also possible for the construct to comprise additional markers such as antibiotic resistances or genes which complement auxotrophies, if appropriate for selecting for the construct.

Regulatory sequences which are advantageous for the preparation are present, for example, in promoters such as the cos, tac, trp, tet, trp-tet, Ipp, lac, 1 pp-lac-, lacIq-T7, T5, T3, gal, trc, ara, rhaP(rhaPBAD) SP6, lambda-PR or imlambda-P promoter, which promoters can advantageously be used in Gram-negative bacteria. Examples of other advantageous regulatory sequences are present in the Gram-positive promoters amy and SP02, and in the yeast or fungal promoters ADC1, MFalpha, AC, P-60, CYC1, GAPDH, TEF, rp28 and ADH.

It is also possible to use artificial promoters for the regulation.

For the purpose of being expressed in a host organism, the nucleic acid construct is advantageously inserted into a vector, such as a plasmid or a phage, which enables the genes to be expressed optimally in the host. Aside from plasmids and phages, vectors are also to be understood as being any other vectors known to the skilled person, that is, for example, viruses such as SV40, CMV, baculovirus and adenovirus, transposons, IS elements, phasmids, cosmids and linear or circular DNA, as well as the Agrobacterium system.

These vectors can be replicated autonomously or chromosomally in the host organism. Examples of suitable plasmids are pLG338, pACYC184, pBR322, pUC18, pUC19, pKC30, pRep4, pHS1, pKK223-3, pDHE19.2, pHS2, pPLc236, pMBL24, pLG200, pUR290, pIN-III″3-B1, tgt11 and pBdCl in E. coli, pIJ101, pIJ364, pIJ702 and pIJ361 in Streptomyces, pUB110, pC194 and pBD214 in Bacillus, pSA77 or pAJ667 in Corynebacterium, pALS1, pIL2 and pBB116 in fungi, 2alpha, pAG-1, YEp6, YEp13 and pEMBLYe23 in yeasts, and pLGV23, pGHlac+, pBIN19, pAK2004 and pDH51 in plants. These plasmids represent a small selection of the possible plasmids. Other plasmids are known to the skilled person and can be found, for example, in the book Cloning Vectors (Eds. Pouwels P. H. et al. Elsevier, Amsterdam-New York-Oxford, 1985, ISBN 0 444 904018).

For expressing the other genes which are present, the nucleic acid construct advantageously also comprises 3′-terminal and/or 5′-terminal regulatory sequences for increasing expression, which sequences are selected for optimal expression in dependence on the chosen host organism and gene or genes.

These regulatory sequences are intended to enable the genes and proteins to be expressed selectively. Depending on the host organism, this can mean, for example, that the gene is only expressed or overexpressed after induction or that it is immediately expressed and/or overexpressed.

In this connection, the regulatory sequences or factors can preferably positively influence, and thereby increase, the expression of the genes which have been inserted. Thus, the regulatory elements can advantageously be augmented at the transcriptional level by using strong transcription signals such as promoters and/or enhancers. Besides that, however, it is also possible to augment translation by, for example, improving the stability of the mRNA.

In another embodiment of the vector, the vector comprising the nucleic acid construct or the nucleic acid can also advantageously be introduced into the microorganisms in the form of a linear DNA and be integrated into the genome of the host organism by means of heterologous or homologous recombination. This linear DNA can comprise a linearized vector, such as a plasmid, or only comprise the nucleic acid construct or the nucleic acid.

In order for heterologous genes to be expressed optimally in organisms, it is advantageous for the nucleic acid sequences to be altered in conformity with the specific codon usage which is employed in the organism. The codon usage can be readily determined using computer analyses of other known genes from the organism concerned.

An expression cassette is prepared by fusing a suitable promoter to a suitable coding nucleotide sequence and a terminator signal or polyadenylation signal. Customary recombination and cloning techniques, as described, for example, in T. Maniatis, E. F. Fritsch and J. Sambrook, Molecular Cloning: A Laboratory Manual, Cold Spring Harbor Laboratory, Cold Spring Harbor, N.Y. (1989) as well as in T. J. Silhavy, M. L. Berman and L. W. Enquist, Experiments with Gene Fusions, Cold Spring Harbor Laboratory, Cold Spring Harbor, N.Y. (1984) and in Ausubel, F. M. et al., Current Protocols in. Molecular Biology, Greene Publishing Assoc. and Wiley Interscience (1987) are used for this purpose.

For expression in a suitable host organism, the recombinant nucleic acid construct or gene construct is advantageously inserted into a host-specific vector which enables the genes to be expressed optimally in the host. Vectors are well known to the skilled person and can be found, for example, in “Cloning Vectors” (Pouwels P. H. et al., Eds., Elsevier, Amsterdam-New York-Oxford, 1985).

Using the vectors, it is possible to prepare recombinant microorganisms which are transformed, for example, with at least one vector and can be employed for producing the hydrophobins, or derivatives thereof, which are used in accordance with the invention. The above-described recombinant constructs are advantageously introduced into, and expressed in, a suitable host system. In this connection, preference is given to using common cloning and transfection methods which are known to the skilled person, such as coprecipitation, protoplast fusion, electroporation, retroviral transfection and the like, in order to express said nucleic acids in the given expression system. Suitable systems are described, for example, in Current Protocols in Molecular Biology, F. Ausubel et al., Eds., Wiley Interscience, New York 1997, or Sambrook et al. Molecular Cloning: A Laboratory Manual. 2 Edition Cold Spring Harbor Laboratory, Cold Spring Harbor Laboratory Press, Cold Spring Harbor, N.Y., 1989.

It is also possible to prepare homologously recombined microorganisms. This involves preparing a vector comprising at least one segment of a gene or coding sequence to be used in which, if appropriate, at least one amino acid deletion, addition or substitution has been introduced in order to alter, e.g. functionally disrupt (knockout vector) the sequence. The introduced sequence can, for example, be a homolog from a related microorganism or else be derived from a mammalian, yeast or insect source. The vector which is used for the homologous recombination can alternatively be designed such that the endogenous gene is mutated or altered in some other way, in connection with homologous recombination, but still encodes the functional protein (e.g. the upstream regulatory region can be altered such that the expression of the endogenous protein is thereby altered). The altered segment of the gene employed in accordance with the invention is in the homologous recombination vector. The construction of vectors which are suitable for homologous recombination is described, for example, in Thomas, K. R. and Capecchi, M. R. (1987) Cell 51: 503.

In principle, any prokaryotic or eukaryotic organisms are suitable for being used as recombinant host organisms for these nucleic acids or these nucleic acid constructs. Microorganisms such as bacteria, fungi or yeasts are advantageously used as host organisms. Gram-positive or Gram-negative bacteria, preferably bacteria of the families Enterobacteriaceae, Pseudomonadaceae, Rhizobiaceae, Streptomycetaceae or Nocardiaceae, particularly preferably bacteria of the genera Escherichia, Pseudomonas, Streptomyces, Nocardia, Burkholderia, Salmonella, Agrobacterium and Rhodococcus, are advantageously used.

The organisms which are used in the above-described method for preparing fusion proteins are grown or cultured in a manner known to the skilled person and in dependence on the host organism. Microorganisms are as a rule grown in a liquid medium comprising a carbon source, usually in the form of sugars, a nitrogen source, usually in the form of organic nitrogen sources such as yeast extract or salts such as ammonium sulfate, trace elements such as iron, manganese and magnesium salts, and also, if appropriate, vitamins, at temperatures of between 0 and 100° C., preferably at from 10 to 60° C., and while being gassed with oxygen. In this connection, the pH of the nutrient liquid can be kept at a fixed value, that is regulated or not during the growth. The growth can take place batchwise, semibatchwise or continuously. Nutrient substances can be initially introduced at the beginning of the fermentation or be subsequently fed in semicontinuously or continuously. The enzymes can be isolated from the organisms using the method described in the examples or be used for the reaction as a crude extract.

The hydrophobins, or functional, biologically active fragments thereof, which are used in accordance with the invention can be prepared by means of a method for recombinant preparation, with a polypeptide-producing microorganism being cultured, if appropriate the expression of the proteins being induced and these proteins being isolated from the culture. The proteins can also be produced in this way on an industrial scale if so desired. The recombinant microorganism can be cultured and fermented using known methods. Bacteria can, for example, be propagated in TB or LB medium at a temperature from 20 to 40° C. and a pH of from 6 to 9. Suitable culturing conditions are described in detail in T. Maniatis, E. Fritsch and J. Sambrook, Molecular Cloning: A Laboratory Manual, Cold Spring Harbor Laboratory, Cold Spring Harbor, N.Y. (1989), for example.

If the proteins are not secreted into the culture medium, the cells are then disrupted and the product is obtained from the lysate using known methods for isolating proteins. The cells can be disrupted, as desired, by means of high frequency ultrasonication, by means of high pressure, for example in a French pressure cell, by means of osmolysis, by the action of detergents, lytic enzymes or organic solvents, by using homogenizers or by using a combination of several of the above-listed methods.

The proteins can be purified using known chromatographic methods, such as molecular sieve chromatography (gel filtration), such as Q sepharose chromatography, ion exchange chromatography and hydrophobic chromatography, as well as using other customary methods such as ultrafiltration, crystallization, salting-out, dialysis and native gel electrophoresis. Suitable methods are described, for example, in Cooper, F. G., Biochemische Arbeitsmethoden [Biochemical working methods], Verlag Walter de Gruyter, Berlin and New York, or in Scopes, R., Protein Purification, Springer Verlag, New York, Heidelberg and Berlin.

It can be particularly advantageous, for facilitating isolation and purification, to provide the hydrophobin fusions with special anchoring groups which are able to bind to corresponding complementary groups on solid supports, in particular suitable polymers. These solid supports can, for example, be used as the filling for chromatography columns, and the efficiency of the separation can as a rule be markedly increased in this way. Such separation methods are also known as affinity chromatography. In order to incorporate the anchoring groups, it is possible, when preparing the proteins, to use vector systems or oligonucleotides which extend the cDNA by particular nucleotide sequences and thereby encode altered proteins or fusion proteins. Proteins which are modified for easier purification comprise what are termed “tags” which function as anchors, for example the modification known as a hexahistidine anchor. Hydrophobin fusions which are modified with histidine anchors can be purified chromatographically, for example, using nickel-sepharose as the column filling. The hydrophobin fusion can then be eluted from the column once again using suitable means for the elution, for example an imidazole solution.

In a simplified purification method, it is possible to dispense with the chromatographic purification. For this, the cells are first of all separated off from the fermentation broth using a suitable method, for example by means of microfiltration or centrifugation. The cells can then be disrupted using suitable methods, for example using the methods which have already been mentioned above, and the cell debris can be separated off from the inclusion bodies. The latter step can advantageously be effected by means of centrifugation. Finally, the inclusion bodies can be disrupted in a manner known in principle in order to release the hydrophobin fusions. This can be effected, by way of example, using acids, bases and/or detergents. The inclusion bodies comprising the hydrophobin fusions which are used in accordance with the invention can as a rule already be dissolved completely within approx. 1 h using 0.1 M NaOH. The purity of the hydrophobin fusions which are obtained using this simplified method is as a rule from 60 to 80% by weight based on the quantity of all the proteins. The solutions which are obtained using the simplified purification method which has been described can be used for implementing this invention without any further purification.

The hydrophobins which have been prepared as described can be used either directly as fusion proteins or as “pure” hydrophobins, after the fusion partner has been cleaved off and removed.

When removal of the fusion partner is envisaged, it is advisable to incorporate a potential cleavage site (specific recognition site for proteases) into the fusion protein between the hydrophobin moiety and the fusion partner moiety. Suitable cleavage sites are, in particular, peptide sequences which do not otherwise occur either in the hydrophobin moiety or in the fusion partner moiety, something which can readily be determined using bioinformatic tools. BrCN cleavage at methionine, or protease-mediated cleavage using factor Xa, enterokinase, thrombin or TEV (tobacco etch virus) protease, for example, are particularly suitable.

According to the invention, the hydrophobins or derivatives thereof can be used for improving phase separation in compositions which comprise at least two liquid phases. In this connection, the compositions can be any compositions as long as they possess at least two liquid phases.

In particular, the compositions can also be compositions which, prior to the addition of the at least one hydrophobin or derivative thereof, are present in the form of an emulsion.

In this connection, the composition can, within the context of the present invention, also possess further phases in addition to the at least two liquid phases.

The at least two liquid phases are two liquid phases of differing density, for example an oil and water, two aqueous solutions of differing density, two organic solutions of differing density, a fuel and water, a combustible and water or a solvent and water. In this connection, an aqueous solution is understood, within the context of the present invention, as meaning solutions which comprise water, if appropriate in combination with an additional solvent. In this connection, each of the liquid phases can, within the context of the present invention, comprise additional substances.

According to the invention, an oil is preferably a crude oil.

Suitable solvents are any liquids which form two-phase mixtures with water, in particular organic solvents, for example ether, aromatic compounds such as toluene or benzene, alcohols, alkanes, alkenes, cycloalkanes, cycloalkenes, esters, ketones, naphthenes or halogenated hydrocarbons.

According to another embodiment, the present invention therefore relates to the use, as previously described, of at least one hydrophobin or at least one derivative thereof, wherein the composition comprising at least two liquid phases is selected from the group consisting of
compositions comprising oil, preferably crude oil, and water,
compositions comprising a fuel or combustible and water,
reaction mixtures comprising at least two liquid phases.

Within the context of the present invention, the composition can also comprise further phases, for example a solid or liquid phase, in particular a solid phase.

It is possible to use the hydrophobins or derivatives thereof for any applications known to the skilled person within this context. Within the context of the present invention, use as a demulsifier in gasoline/water mixtures and as a demulsifier in other fuel or combustible/water mixtures, phase separation in connection with chemical reactions, in particular in connection with large-scale industrial processes, the breaking of emulsions between crude oil and water in connection with crude oil extraction or crude oil production, as well as the desalting of crude oil by extracting crude oil with water and then breaking the resulting emulsion, are to be mentioned, in particular. Suitable large-scale industrial chemical processes are all those in which phase separation is to be brought about, for example the hydroformylation of polyisobutene using cobalt catalysts, with the catalysts being separated off under aqueous conditions.

The hydrophobins or derivatives thereof are also used, in accordance with the invention, for improving the phase separation of compositions which comprise at least two liquid phases and which arise during the course of a reaction, i.e. which are formed during the course of a reaction or which arise due to the addition of a solvent or of a component. The use, according to the invention, of hydrophobins or derivatives thereof abbreviates the phase separation time and can reduce the loss of products of value.

It is likewise possible, in accordance with the invention, to improve the phase separation of compositions which comprise two aqueous phases of differing density, with an aqueous phase being understood as being a phase comprising water, if appropriate in combination with another solvent. According to the invention, hydrophobins or derivatives thereof can, for example, be used to improve phase separation in connection with fractionating polymers in aqueous systems. Water-soluble polymers, in particular, are fractionated in this connection.

In a general manner, mention is to be made of all the water-soluble and oil-soluble polymers known to the skilled person, in particular polyacrylates and their copolymers which, determined by the preparation, accrue with a molar mass distribution or polydispersity of greater than 1.1.

Emulsions can be broken by adding demulsifiers. Thus, for example, extracted mineral oil is as a rule present as a relatively stable water-in-oil emulsion which can comprise up to 90% by weight of water depending on the nature of the deposit. When the crude oil is worked-up and purified, a crude oil accrues, after a major part of the water has been separated off, which still comprises from approx. 2 to 3% by weight of water. This latter forms a stable emulsion with the oil, which emulsion cannot be completely separated off even by centrifuging and adding conventional demulsifiers. This constitutes a problem insofar as, in the first place, the water comprises a high content of salt and thus has a corroding effect and, in the second place, the residual water increases the volume which has to be transported and stored, with this leading to an increase in costs. In accordance with the invention, it was found that hydrophobins or derivatives thereof can be used particularly advantageously to improve phase separation in these compositions. A very rapid separation is achieved.

In this connection, the demulsifier must be adapted to the nature of the emulsified oils and fats, as well as to any emulsifiers and surfactants which may be present, in order to achieve an optimal effect. The breaking of emulsions can be additionally supported by an elevated temperature, for example a temperature of from 0 to 100° C., for example of from 10 to 80° C., in particular of from 20 to 60° C.

Examples of other applications in accordance with the invention include the demulsification of impregnating emulsions in the chipboard and textile industry, and of medicament emulsions. Another application is the demulsification of organically treated effluents, for example industrial and trade effluents, in particular from metal working, for example cutting fluids from metal working, from tanneries and from mineral oil refineries and domestic sources, in which oil/water emulsions accrue. Such effluents arise, for example, in connection with processing mineral oil in refineries and petrochemical plants. Before these effluents can be conducted to the clarification plant, it is necessary to separate off oil residues, which are frequently present in the form of an emulsion.

Another application in accordance with the invention is the demulsification of oil-in-water or water-in-oil mixtures, for example emulsions which have been used as cutting fluids and are to be recycled. Water/oil mixtures also accrue, for example, as bilge water onboard sea-going ships. In this connection, it is necessary to separate emulsions in order to be able to separate off the water and reduce the quantity of solvent which has to be disposed of.

The quantity of the hydrophobin or derivative thereof which is used can vary over a wide range, with the quantity advantageously being matched to the composition per se and, if appropriate, to other components present in the composition.

If, for example, the composition comprises substances, for example surfactants or emulsifiers, which delay or impair the separation of the at least two liquid phases, a larger quantity of a hydrophobin or a derivative thereof is then advantageously employed.

Since oils, in particular crude oils, are composed of a mixture of many chemical compounds, it is necessary, because of the different chemical composition of the oil and of the water and salt fractions, as well as the specific conditions of the demulsification, such as temperature, duration of the demulsification, nature of the proportioning and interactions with other components of the mixture, to match the demulsifier to the specific conditions.

It has been found, surprisingly, that even small quantities of a of a hydrophobin or derivative thereof lead to an improvement in the phase separation.

According to the invention, the at least one one hydrophobin or derivative thereof can be used in any suitable quantity. The at least one hydrophobin or derivative thereof is used, as a rule, in a quantity of from 0.0001 to 1000 ppm, based on the total composition; preferably in a quantity of from 0.001 to 500 ppm, particularly preferably of from 0.01 to 200 ppm or of from 0.01 to 100 ppm and very particularly preferably of from 0.1 to 50 ppm.

In the context of the present invention, ppm denotes mg per kg.

According to another embodiment, the present invention therefore relates to a use as previously described wherein the at least one hydrophobin or the at least one derivative thereof is employed in a quantity of from 0.0001 to 1000 ppm, based on the total composition. The concentration employed is specified by the skilled person depending on the nature of the composition to be demulsified.

If the composition is a composition comprising fuel or combustibles and water, the hydrophobin or derivative thereof is employed, as a rule, in a quantity of from 0.001 to 10 ppm, preferably of from 0.005 to 2 ppm, in particular of from 0.01 to 1 ppm, particularly preferably of from 0.05 to 0.5 ppm and more preferably of from 0.01 to 0.1 ppm.

If the composition is a composition comprising crude oil and water, the hydrophobin or derivative thereof is employed, as a rule, in a quantity of from 1 to 1000 ppm, preferably of from 1 to 800 ppm, in particular of from 5 to 500 ppm, particularly preferably of from 10 to 200 ppm and more preferably of from 15 to 100 ppm and, for example, of from 20 to 50 ppm.

If the composition is a composition comprising two aqueous phases of differing density, which phases can arise, for example, in connection with fractionating water-soluble polymers, the hydrophobin or derivative thereof is employed, as a rule, in a quantity of from 1 to 1000 ppm, preferably of from 1 to 500 ppm, in particular of from 5 to 250 ppm, particularly preferably of from 10 to 200 ppm and more preferably of from 15 to 100 ppm.

According to the invention, it is also possible for the composition to comprise further compounds which improve phase separation, in addition to the at least one hydrophobin or derivatives thereof. In this connection, the compounds can be any compounds which are known to the skilled person for applications of this nature. Examples of compounds which are suitable for use as further compounds for improving phase separation, in particular for the application as demulsifiers in connection with crude oil production, are oxyalkylated phenol formaldehyde resins, EO/PO block copolymers, crosslinked diepoxides, polyamides or their alkoxylates, salts of the sulfonic acids, ethoxylated fatty amines, succinates and the compounds which are specified in DE 10 2005 006 030.7 for applications of this nature.

According to another embodiment, the present invention therefore relates to a use as previously described, wherein at least one further compound which improves phase separation is employed in addition to at least one hydrophobin or the at least one derivative thereof.

According to another aspect, the present invention also relates to a method for separating at least two liquid phases in a composition comprising at least two liquid phases, with the method comprising the addition of at least one hydrophobin or at least one derivative thereof to the composition.

In this connection, the composition can be a composition as previously described comprising at least two liquid phases.

According to a preferred embodiment, the present invention therefore relates to a method of this nature, wherein the composition comprising at least two liquid phases is selected from the group consisting of
compositions comprising oil, preferably crude oil, and water,
compositions comprising a fuel or combustible and water,
reaction mixtures comprising at least two liquid phases.

In principle, the hydrophobins or derivatives thereof can, within the context of the present invention, be employed in any arbitrary quantities provided the phase separation is improved. The use of a hydrophobin or derivative thereof in a quantity of from 0.0001 to 1000 ppm, based on the total composition, is particularly suitable.

The present invention likewise relates to a previously described method wherein the at least one hydrophobin or the at least one derivative thereof is employed in a quantity of from 0.0001 to 1000 ppm, based on the total composition. Preferred quantities for the respective systems have already been mentioned.

The method according to the invention can comprise additional steps, for example steps which improve phase separation or the breaking of emulsions. In this connection, the step can, for example, be an increase in temperature or a centrifugation. Such a step can be effected before, during or after the addition of the at least one hydrophobin or derivative thereof.

According to another embodiment, the present invention therefore relates to a method as previously described, wherein the method comprises, before or after the addition of the at least one hydrophobin or the at least one derivative thereof, increasing the temperature of the composition comprising at least two liquid phases.

According to the invention, hydrophobins or derivatives thereof can be added, for example, to formulations comprising fuels or combustibles. This enables rapid segregation to take place when the formulation comes into contact with water, or prevents the formation of emulsions. The formation of emulsions in storage tanks, for example, would make it necessary to subject the formulation to elaborate purification steps.

It is likewise advantageous to add hydrophobins or derivatives thereof to crude oils in order, for example, to prevent the formation of emulsions.

In this connection, the formulation comprising fuels or combustibles can, within the context of the present invention, comprise further additives which are customarily present in formulations of this nature.

Suitable additives are specified, for example, in WO 2004/087808.

The present invention therefore also relates to a formulation comprising at least one compound selected from the group consisting of fuels, combustibles, crude oils or water-soluble or oil-soluble polymer solutions and at least one hydrophobin or derivatives thereof.

The quantity of the hydrophobin or derivative thereof employed can vary, depending on the other substances added, as long as an improvement in phase separation when the formulation comes into contact with water is ensured.

According to the invention, the quantity of the hydrophobin or derivative thereof employed is preferably in the range of from 0.0001 to 1000 ppm, preferably of from 0.001 to 500 ppm, particularly preferably of from 0.01 to 100 ppm.

The present invention therefore also relates to a formulation as previously described, wherein the hydrophobin or the derivative thereof is present in the formulation in a quantity of from 0.0001 to 1000 ppm, based on the total formulation.

If the formulation is a mixture comprising a crude oil, the hydrophobin or derivative thereof is added to this formulation in, as a rule, a quantity of from 1 to 1000 ppm, preferably of from 10 to 800 ppm, in particular of from 10 to 500 ppm.

If the formulation is a mixture comprising fuels or combustibles, the hydrophobin or derivative thereof is added to this formulation in, as a rule, a quantity of from 0.001 to 0.5 ppm, preferably of from 0.005 to 0.3 ppm, in particular of from 0.01 to 0.2 ppm.

Therefore, according to another embodiment, the present invention relates to a formulation as previously described, wherein the formulation comprises at least one fuel or combustible and the hydrophobin or the derivative thereof is present in the formulation in a quantity of from 0.001 to 0.5 ppm, based on the total formulation.

Within the context of the present invention, combustibles are understood as being, for example, light, medium or heavy heating oils.

Within the context of the present invention, fuels are understood as being, for example, gasolines, diesel fuels or turbine fuels. They are particularly preferably gasolines.

The fuels can comprise further additives. The skilled person is in principle familiar with customary additives. Suitable additives and solvents are specified, for example, in WO 2004/087808.

According to the invention, additives having a detergent effect and/or having a valve seat wear-inhibiting effect (termed detergent additives in that which follows) are, for example, suitable for use as further additive components. This detergent additive possesses at least one hydrophobic hydrocarbon residue having a number-averaged molecular weight Mₙ of from 85 to 20 000 g/mol and at least one polar grouping selected from:

(a) monoamino or polyamino groups having up to 6 nitrogen atoms, with at least one nitrogen atom possessing basic properties;
(b) nitro groups, if appropriate in combination with hydroxyl groups;
(c) hydroxyl groups in combination with monoamino or polyamino groups, with at least one nitrogen atom possessing basic properties;
(d) carboxyl groups or their alkali metal or alkaline earth metal salts;
(e) sulfonic acid groups or their alkali metal or alkaline earth metal salts;
(f) polyoxy-C2 to C4-alkylene groupings which are terminated by hydroxyl groups, monoamino or polyamino groups, with at least one nitrogen atom possessing basic properties, or carbamate groups;
(g) carboxylic ester groups;
(h) succinic anhydride-derived groupings possessing hydroxyl and/or amino and/or amido and/or imido groups; and/or
(i) groupings produced by the Mannich reaction of substituted phenols with aldehydes and monoamines or polyamines.

The hydrophobic hydrocarbon residue in the above detergent additives, which residue is responsible for adequate solubility in the fuel, has a number-averaged molecular weight (Mn) of from 85 to 20 000, in particular of from 113 to 10 000, especially of from 300 to 5000. The polypropenyl, polybutenyl and polyisobutenyl residues, having in each case an Mn=300 to 5000, in particular 500 to 2500, especially 700 to 2300, come into consideration as typical hydrophobic hydrocarbon residues, in particular in combination with the polar groupings (a), (c), (h) and (i).

The following may be mentioned as examples of the above groups of detergent additives:

Additives comprising monoamino or polyamino groups (a) are preferably polyalkene monoamines or polyalkene polyamines based on polypropylene or conventional (i.e. possessing double bonds which are predominantly located centrally) polybutene or polyisobutene having an Mₙ of from 300 to 5000. If polybutene or polyisobutene having double bonds which are predominantly located centrally (usually in the beta and gamma positions) are used as the starting material for preparing the additives, the routes of preparation by chlorinating and then aminating or by oxidizing the double bond with air or ozone to give the carbonyl or carboxyl compound and then aminating under reductive (hydrogenating) conditions are then suitable. In this case, amines, such as ammonia, monoamines or polyamines, such as dimethylaminopropylamine, ethylenediamine, diethylenetriamine, triethylenetetraamine or tetraethylenepentamine can be used for the amination. Corresponding additives based on polypropylene are described, in particular, in WO 94/24231.

Other preferred additives comprising monoamino groups (a) are the hydrogenation products of the products arising from the reaction of polyisobutenes having an average degree of polymerization P=5 to 100 with nitrogen oxides or mixtures of nitrogen oxides and oxygen, as are described, in particular, in WO 97/03946.

Other preferred additives comprising monoamino groups (a) are the compounds which can be obtained from polyisobutene epoxides by reaction with amines and subsequent dehydration and reduction of the amino alcohols, as are described, in particular, in DE-A 196 20 262.

Additives comprising nitro groups (b), if appropriate in combination with hydroxyl groups, are preferably products from the reaction of polyisobutenes having an average degree of polymerization P=5 to 100 or 10 to 100 with nitrogen oxides or mixtures of nitrogen oxides and oxygen, as are described, in particular, in WO 96/03367 and WO 96/03479. These reaction products are as a rule mixtures of pure nitropolyisobutenes (e.g. alpha, beta-dinitropolyisobutene) and mixed hydroxynitropolyisobutenes (e.g. alpha-nitro-beta-hydroxypolyisobutene).

Additives comprising hydroxyl groups in combination with monoamino or polyamino groups (c) are, in particular, products of the reaction of polyisobutene epoxides which can be obtained from polyisobutene which possesses double bonds which are preferably predominantly terminal and has an Mn=300 to 5000 using ammonia or monoamines or polyamines, as are described, in particular, in EP-A 0 476 485.

Additives comprising carboxyl groups or their alkali metal or alkaline earth metal salts (d) are preferably copolymers of C2-C40 olefins with maleic anhydride having a total molar mass of from 500 to 20 000 whose carboxyl groups are entirely or partially reacted to give the alkali metal or alkaline earth metal salts and a remainder of the carboxyl groups being reacted with alcohols or amines. These additives are disclosed, in particular, in EP-A 0 307 815. Additives of this nature are principally used for preventing valve seat wear and can, as described in WO 87/01126, advantageously be employed in combination with customary fuel detergents such as poly(iso)buteneamines or polyether amines.

Additives comprising sulfonic acid groups or their alkali metal or alkaline earth metal salts (e) are preferably alkali metal or alkaline earth metal salts of an alkyl sulfosuccinate, as is described, for example, in EP-A 0 63.

Additives of this nature are principally used for preventing valve seat wear and can advantageously be employed in combination with customary fuel detergents such as poly(iso)buteneamines or polyether amines.

Additives comprising polyoxy-C2-C4-alkylene groupings (f) are preferably polyethers or polyether amines which can be obtained by reacting C2-C60-alkanols, C6-C30-alkanediols, mono- or di-C2-C30-alkylamines, C1-C30-alkylcyclohexanols or C1-C30-alkylphenols with from 1 to 30 mol of ethylene oxide and/or propylene oxide and/or butylene oxide per hydroxyl group or amino group and, in the case of the polyether amines, by subsequent reductive amination with ammonia, monoamines or polyamines. Products of this nature are described, in particular, in EP-A 875, EP-A 725, EP-A 985 and U.S. Pat. No. 4,877,416. In the case of polyethers, these products also satisfy flotation oil qualities. Typical examples in this regard are tridecanol or isotridecanol butoxylates, isononylphenol butoxylates and polyisobutenol butoxylates and propoxylates as well as the corresponding products of reaction with ammonia.

Additives comprising carboxylic ester groups (g) are preferably esters of mono-, di- or tricarboxylic acids with long-chain alkanols or polyols, in particular those having a minimum viscosity of 2 mm²/s at 100° C., as are described, in particular, in DE-A 3 918. The mono-, di- or tricarboxylic acids which can be used are aliphatic or aromatic acids, while suitable ester alcohols or polyols are, in particular, long-chain representatives having, for example, from 6 to 24 C atoms. Adipates, phthalates, isophthalates, terephthalates and trimellitates of isooctanol, isononanol, isodecanol and isotridecanol are typical representatives of the esters. Products of this nature also satisfy flotation oil qualities.

Additives comprising succinic anhydride-derived groupings having hydroxyl and/or amino and/or amido and/or imido groups (h) are preferably corresponding derivatives of polyisobutenylsuccinic anhydride which can be obtained by the reaction of conventional or highly reactive polyisobutene having an Mn=300 to 5000 with maleic anhydride either by means of heating or by way of the chlorinated polyisobutene. Of particular interest in this connection are derivatives with aliphatic polyamines such as ethylenediamine, diethylenetriamine, triethylenetetraamine or tetraethylenepentamine. Gasoline additives of this nature are described, in particular, in U.S. Pat. No. 4,849,572.

Additives comprising groupings (i) produced by the Mannich reaction of substituted phenols with aldehydes and monoamines or polyamines are preferably products of the reaction of polyisobutene-substituted phenols with formaldehyde and monoamines or polyamines such as ethylenediamine, diethylenetriamine, triethylenetetraamine, tetraethylenepentamine or dimethylaminopropylamine. The polyisobutenyl-substituted phenols can be derived from conventional or highly reactive polyisobutene having an Mn=300 to 5000. “Polyisobutene Mannich bases” of this nature are described, in particular, in EP-A 141.

For the purpose of more precisely defining the individual gasoline additives which are listed, the disclosures of the abovementioned documents of the prior art are expressly incorporated herein by reference.

In this connection, said additives are employed in quantities which appear suitable to the skilled person for the given application.

In addition to this, the formulations according to the invention can also be combined with other customary components and additives. Flotation oils without any pronounced detergent effect may be mentioned here by way of example.

Suitable mineral flotation oils are fractions which accrue in connection with mineral oil processing, such as brightstock, or base oils having viscosities such as, for example, from the SN 500-2000 class; and also aromatic hydrocarbon, paraffinic hydrocarbons and alkoxyalkanols. A fraction which accrues in connection with refining mineral oil and is known as “hydrocrack oil” (vacuum distillate cut which has a boiling range of from about 360 to 500° C. and which can be obtained from natural mineral oil which has been catalytically hydrogenated and isomerized under high pressure and also deparaffinized) is likewise suitable in accordance with the invention. Mixtures of the abovementioned mineral flotation oils are also suitable.

Examples of synthetic flotation oils which can be used in accordance with the invention are selected from: polyolefins (poly alpha olefins or poly internal olefins), (poly)esters, (poly)alkoxylates, polyethers, aliphatic polyether amines, alkylphenol-started polyethers, alkylphenol-started polyether amines and carboxylic esters of long-chain alkanols.

Examples of suitable polyolefins are olefin polymers having an Mn=400 to 1800, especially on a polybutene or polyisobutene basis (hydrogenated or not hydrogenated).

Examples of suitable polyethers or polyether amines are, preferably, compounds comprising polyoxy-C2-C4-alkylene groupings and which can be obtained by reacting C2-C60-alkanols, C6-C30-alkanediols, mono- or di-C2-C30-alkylamines, C1-C30-alkylcyclohexanols or C1-C30-alkylphenols with from 1 to 30 mol of ethylene oxide and/or propylene oxide and/or butylene oxide per hydroxyl group or amino group and, in the case of the polyether amines, by subsequent reductive amination with ammonia, monoamines or polyamines. Products of this nature are described, in particular, in EP-A 0 310 875, EP-A 0 356 725, EP-A 0 700 985 and U.S. Pat. No. 4,877,416. Examples of polyetheramines which can be used are poly-C2-C6-alkylene oxide amines, or functional derivatives thereof. Typical examples of this are tridecanol or isotridecanol butoxylates, isononylphenol butoxylates and polyisobutenol butoxylates and propoxylates, as well as the corresponding reaction products with ammonia.

Examples of carboxylic esters of long-chain alkanols are, in particular, esters of mono-, di- or tricarboxylic acids with long-chain alkanols or polyols, as are described, in particular, in DE-A 38 38 918. The mono-, di- or tricarboxylic acids which can be used are aliphatic or aromatic acids, while suitable ester alcohols or polyols are, in particular, long-chain representatives having, for example, from 6 to 24 C atoms. Typical representatives of the esters are adipates, phthalates, isophthalates, terephthalates and trimellitates of isooctanol, isononanol, isodecanol and isotridecanol, such as, for example, di-(n- or iso-tridecyl) phthalate.

Examples of other suitable flotation oil systems are described in DE-A 38 26 608, DE-A 41 42 241, DE-A 43 09 074, EP-A 0 452 328 and EP-A 0 548 617, which are hereby expressly incorporated by reference.

Examples of particularly suitable synthetic flotation oils are alcohol-started polyethers having from about 5 to 35, for example from about 5 to 30, C3-C6-alkylene oxide units, which are selected, for example, from propylene oxide, n-butylene oxide and i-butylene oxide units, or mixtures thereof. Non-limiting examples of suitable starter alcohols are long-chain alkanols or long-chain alkyl-substituted phenols, with the long-chain alkyl radical in particular being a straight-chain or branched C6-C18 alkyl radical.

Tridecanol and nonylphenol may be mentioned as preferred examples.

Further suitable synthetic flotation oils are alkoxylated alkylphenols, as are described in DE-A 10 102 913.6.

In this connection, said flotation oils are employed in quantities which appear suitable to the skilled person for the given application.

Other customary additives are corrosion inhibitors, for example based on ammonium salts of organic carboxylic acids, which salts tend to form films, or on heterocyclic aromatic compounds in the case of nonferrous metal corrosion protection; antioxidants or stabilizers, for example based on amines such as p-phenylenediamine, dicyclohexylamine, or derivatives thereof, or on phenols such as 2,4-di-tert-butylphenol or 3,5-di-tert-butyl-4-hydroxyphenylpropionic acid; further conventional demulsifiers; antistatic agents; metallocenes such as ferrocene; methylcyclopentadienyl manganese tricarbonyl; lubricity additives such as certain fatty acids, alkenylsuccinic esters, bis(hydroxyalkyl) fatty amines, hydroxyacetamides or castor oil; and also dyes (markers). If appropriate, amines are also added for the purpose of lowering the pH of the fuel.

Said detergent additives containing the polar groupings (a) to (i) are customarily added to the fuel in a quantity of from 10 to 5000 ppm by weight, in particular of from 50 to 1000 ppm by weight. The other components and additives mentioned are, if desired, added in quantities which are customary for this purpose.

Fuels and combustibles which are suitable in accordance with the invention are any fuels and combustibles known to the skilled person, for example gasolines as are described, for example, in Ullmann's Encyclopedia of Industrial Chemistry, 5th edtn. 1990, Volume A16, pp. 719ff. Diesel fuel, kerosene and jet fuel are also suitable fuels in accordance with the invention.

In particular, a gasoline having an aromatic compound content of at most 60, for example at most 42% by volume, and a sulfur content of at most 2000, for example at most 150 ppm by weight, is suitable.

The aromatic compound content of the gasoline is, for example, from 10 to 50, for example from 30 to 42% by volume, in particular from 32 to 40% by volume. The sulfur content of the gasoline is, for example, from 2 to 500, for example from 5 to 150 ppm by weight, or from 10 to 100 ppm by weight.

Furthermore, a suitable gasoline can, for example, have an olefin content of up to 50% by volume, for example from 6 to 21% by volume, in particular from 7 to 18% by volume; a benzene content of up to 5% by volume, for example from 0.5 to 1.0% by volume, in particular from 0.6 to 0.9% by volume, and/or an oxygen content of up to 25% by weight, for example of up to 10% by weight or of from 1.0 to 2.7% by weight, in particular of from 1.2 to 2.0% by weight.

In particular, mention may be made, by way of example, of gasolines which simultaneously have an aromatic compound content of at most 38% by volume, an olefin content of at most 21% by volume, a sulfur content of at most 50 ppm by weight, a benzene content of at most 1.0% by volume and an oxygen content of from 1.0 to 2.7% by weight.

The content of alcohols and ethers in the gasoline can vary over a wide range. Examples of typical maximum contents are 15% by volume in the case of methanol, 65% by volume in the case of ethanol, 20% by volume in the case of isopropanol, 15% by volume in the case of tert-butanol, 20% by volume in the case of isobutanol and 30% by volume in the case of ethers having 5 or more C atoms in the molecule.

The Sommer vapor pressure of a gasoline which is suitable in accordance with the invention is customarily at most 70 kPa, in particular 60 kPa (in each case 37° C.).

As a rule, the RON of the gasoline is from 75 to 105. A customary range for the corresponding MON is from 65 to 95.

Said specifications are determined using customary methods (DIN EN 228).

The invention is explained in more detail below by means of examples.

### EXAMPLES

### Example 1

### Preliminary Work for Cloning yaad-His₆/yaaE-His₆

A polymerase chain reaction was carried out using the oligonucleotides Ha1570 and Ha1571 (Hal 572/Hal 573). Genomic DNA from the bacterium Bacillus subtilis was used as the template DNA. The resulting PCR fragment comprised the coding sequence of the Bacillus subtilis yaaD/yaaE gene and in each case an NcoI and, respectively, BglII restriction cleavage site at the ends. The PCR fragment was purified and cut with the restriction endonucleases NcoI and BgIII. This DNA fragment was used as an insert and cloned into the Qiagen vector pQE60, which has been previously linearized with the restriction endonucleases NcoI and BgIII. The vectors which were obtained in this way, i.e. pQE60YAAD#2/-pQE60YaaE#5, can be used for expressing proteins comprising YAAD::HIS₆ and, respectively, YAAE::HIS₆.

| | |
|---|---|
| HaI570: | gcgcgcccatggctcaaacaggtactga |
| HaI571: | gcagatctccagccgcgttcttgcatac |
| HaI572: | ggccatgggattaacaataggtgtactagg |
| HaI573: | gcagatcttacaagtgccttttgcttatattcc |

### Example 2

### Cloning yaad Hydrophobin DewA-His₆

A polymerase chain reaction was carried out using the oligonucleotides KaM 416 and KaM 417. Genomic DNA from the mold Aspergillus nidulans was used as the template DNA. The resulting PCR fragment comprised the coding sequence of the hydrophobin gene dewA and a sequence encoding a N-terminal factor Xa proteinase cleavage site. The PCR fragment was purified and cut with the restriction endonuclease BamHI. This DNA fragment was used as an insert and cloned into the vector pQE60YAAD#2, which has been previously linearized with the restriction endonuclease BgIII.

The vector #508, which was obtained in this way, can be used for expressing a fusion protein comprising YAAD::Xa::dewA::HIS₆.

KaM416:
GCAGCCCATCAGGGATCCCTCAGCCTTGGTACCAGCGC
KaM417:
CCCGTAGCTAGTGGATCCATTGAAGGCCGCATGAAGTTCTCCGTCTCCGC

### Example 3

### Cloning yaad-Hydrophobin RodA-His₆

The plasmid #513 was cloned in analogy with plasmid #508 using the oligonucleotides KaM 434 and KaM 435.

KaM434:
GCTAAGCGGATCCATTGAAGGCCGCATGAAGTTCTCCATTGCTGC
KaM435:
CCAATGGGGATCCGAGGATGGAGCCAAGGG

### Example 4

### Cloning yaad-Hydrophobin BASF1-His₆

The plasmid #507 was cloned in analogy with plasmid #508 using the oligonucleotides KaM 417 and KaM 418.

An artificially synthesized DNA sequence, i.e. hydrophobin BASF1, was used as the template DNA (see Annex, SEQ ID NOS. 11 and 12).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### Example 5

### Cloning yaad-Hydrophobin BASF2-His₆

The plasmid #506 was cloned in analogy with plasmid #508 using the oligonucleotides KaM 417 and KaM 418.

An artificially synthesized DNA sequence, i.e. hydrophobin BASF2, was used as the template DNA (see Annex, SEQ ID NOS. 13 and 14).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### Example 6

### Cloning yaad-Hydrophobin SC3-His₆

The plasmid #526 was cloned in analogy with plasmid #508 using the oligonucleotides KaM464 and KaM465.

Schyzophyllum commune cDNA was used as the template DNA (see Annex, SEQ ID NOS. 9 and 10).

| | |
|---|---|
| KaM464: | CGTTAAGGATCCGAGGATGTTGATGGGGGTGC |
| KaM465: | GCTAACAGATCTATGTTCGCCCGTCTCCCCGTCGT |

### Example 7

### Fermentin the Recombinant E. Coli Strain yaad-Hydrophobin DewA-His₆

Inoculation of 3 ml of LB liquid medium with a yaad-hydrophobin DewA-His₆-expressing E. coli strain in 15 ml Greiner tubes. Incubation at 37° C. for 8 h on a shaker at 200 rpm. In each case 2 1l Erlenmeyer flasks possessing baffles and containing 250 ml of LB medium (+100 μg of ampicillin/ml) are inoculated with in each case 1 ml of the preliminary culture and incubated at 37° C. for 9 h on a shaker at 180 rpm.

13.5 l of LB medium (+100 μg of ampicillin/ml) in a 20 l fermenter are inoculated with 0.5 l of preliminary culture (OD_{600 nm} 1:10 measured against H₂O). 140 ml of 100 mM IPTG are added at an OD_{60 nm} of ˜3.5. After 3 h, the fermenter is cooled down to 10° C. and the fermentation broth is centrifuged down. The cell pellet is used for the further purification.

### Example 8

### Purifying the Recombinant Hydrophobin Fusion Protein

(Purifying Hydrophobin Fusion Proteins which Possess a C-Terminal His6 Tag)

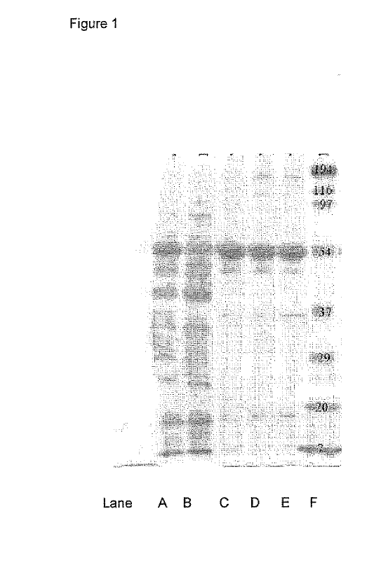

100 g of cell pellet (100-500 mg of hydrophobin) are made up to a total volume of 200 ml with 50 mM sodium phosphate buffer, pH 7.5, and resuspended. The suspension is treated with an Ultraturrax type T25 (Janke and Kunkel; IKA-Labortechnik) for 10 minutes and then incubated with 500 units of Benzonase (Merck, Darmstadt; Order No. 1.01697.0001), at room temperature for 1 hour, in order to break down the nucleic acids. Prior to the cell disruption, filtration is carried out using a glass cartridge (P1). Two homogenizer runs at 1500 bar (Microfluidizer M-110EH; Microfluidics Corp.) are carried out in order to disrupt the cells and to shear the remaining genomic DNA. The homogenate is centrifuged (Sorvall RC-5B, GSA-Rotor, 250 ml centrifuge cups, 60 minutes, 4° C., 12 000 rpm, 23 000 g), the supernatant is placed on ice and the pellet is resuspended in 100 ml of sodium phosphate buffer, pH 7.5. The centrifugation and resuspension are repeated three times, with the sodium phosphate buffer comprising 1% SDS for the third repetition. Following the resuspension, the mixture is stirred for one hour and a final centrifugation is carried out (Sorvall RC-5B, GSA rotor, 250 ml centrifuge cups, 60 minutes, 4° C., 12 000 rpm, 23 000 g). SDS-PAGE analysis indicates that, after the final centrifugation, the hydrophobin is in the supernatant (FIG. 1). The experiments show that the hydrophobin is probably present in the form of inclusion bodies in the corresponding E. coli cells. 50 ml of the hydrophobin-comprising supernatant are loaded onto a 50 ml nickel-Sepharose high performance 17-5268-02 column (Amersham) which has been equilibrated with 50 mM Tris-Cl, pH 8.0, buffer. The column is washed with 50 mM Tris-Cl, pH 8.0, buffer and the hydrophobin is then eluted with 50 mM Tris-Cl, pH 8.0, buffer comprising 200 mM imidazole. In order to remove the imidazole, the solution is dialyzed against 50 mM Tris-Cl, pH 8.0, buffer.

FIG. 1 shows the purification of the hydrophobin which was prepared:

Lane A: Material loaded on the nickel-sepharose column (diluted 1:10)

Lane B: Flow through =eluate from washing step

Lanes C-E: OD 280 maxima of the elution fractions (WP1, WP2, WP3)

Lane F shows the applied marker.

The hydrophobin in FIG. 1 has a molecular weight of approx. 53 kD. Some of the smaller bands represent breakdown products of the hydrophobin.

### Example 9

### Application Test; Characterizing the Hydrophobin by the Change in the Angle of Contact of a Water Drop on Glass

### Substrate:

Glass (window glass, Süddeutsche Glas, Mannheim):

The hydroprobin which was purified as described in example 8 was used.
concentration of the hydrophobin in the solution: 100 μg/ml, the solution additionally comprised 50 mM Na acetate buffer and also 0.1% of polyoxyethylene (20) sorbitan monolaureate (Tween® 20)), pH of the solution: 4
glass platlet immersed in this solution overnight (temperature 80° C.)
   after that, the hydrophobin-coated glass platelet is removed from the solution and washed in distilled water,
   after that, incubation, 10 min/80° C./1% SDS solution, in dist. water
   renewed washing in dist. water
   after that, incubated at 80° C. for 10 min/1% SDS solution in dist. water
   washed again in dist. water

The samples are dried in air and the contact angle (in degrees) of a drop of 5 μl of water with the coated glass surface is determined at room temperature.

The contact angle measurement was performed on a Dataphysics Contact Angle System OCA 15+, Software SCA 20.2.0 (November 2002), instrument. The measurement was carried out in accordance with the manufacturer's instructions.

Untreated glass gave a contact angle of 30±5°;

The glass platelet coated with the hydrophobin in accordance with Example 8 (yaad-dewA-his₆) gave a contact angle of 75±5°.

==>increase in the contact angle: 45°

### Example 10

### Using a Hydrophobin Concentrate (yaad-Xa-dewA-His₆) as an Additive in Fuels

### Principle of the Experiment:

Modern fuels customarily comprise a number of different additives (what are termed additive packages). If, during the course of its production or marketing route, the fuel comes into contact with water, these additives can display an emulsifying effect and lead to the formation of undesirable fuel-water emulsions. In order to avoid this effect, demulsifiers are therefore customarily added to the fuels.

The demulisfying experiments were carried out using a hydrophobin concentrate as described in Example 8 (SEQ ID NOS. 19 and 20).

The hydrophobin concentrate was diluted with ethanol and added to a commercially available Eurosuper fuel (in accordance with EN 228) which already comprised 725 mg of a special performance additive package A/kg. This additive package principally comprises the polyisobuteneamine Kerocom PIBA, flotation oil mixtures, solvents, corrosion inhibitor and friction modifier.

Fuel samples comprising 0.01, 0.03, 0.05, 0.07, 0.14 and 0.28 mg of hydrophobin/kg were prepared. The fuel to which only A had been added, and which did not contain hydrophobin, served as reference (10-V1). In another comparative experiment (10-V2), 1.45 mg of a commercially available demulsifier D based on the phenol resins (ADX 606, from Lubrizol) were used/kg.

Emulsion tests were carried out in accordance with DIN 51415 using each of the fuel samples. In this connection, in each case 80 ml of fuel and 20 ml of water are mixed thoroughly with each other. After that, the demixing process in dependence on time is observed. The analysis takes place using standards which are preset in the norm, with 1 standing for very good demixing and larger numbers standing for increasingly inferior demixing. The details are contained in the cited DIN norm.

Table 1 summarizes results obtained in experiments. The table lists the assessments of the phase separation layers which are in each case made after 1 min, 5 min, 30 min and 60 min. As a rule, a 1 or 1b assessment after 5 minutes is demanded.

TABLE 1

| | | | | 30 | 60 |
|---|---|---|---|---|---|
| No. | | 1 min. | 5 min. | min. | min |
| 10-V1 | A | 4 | 4 | 2 | 1b |
| (comparative) | | | | | |
| 10-V2 | A + 1.45 mg of D/kg | 1b | 1 | 1 | 1 |
| (comparative) | | | | | |
| 10-1 | A + 0.01 mg of H./kg | 1b | 1 | 1 | 1 |
| 10-2 | A + 0.03 mg of H./kg | 1b | 1 | 1 | 1 |
| 10-3 | A + 0.05 mg of H./kg | 1b | 1 | 1 | 1 |
| 10-4 | A + 0.07 mg of H./kg | 1b | 1 | 1 | 1 |
| 10-5 | A + 0.14 mg of H./kg | 1b | 1 | 1 | 1 |
| 10-6 | A + 0.28 mg of H./kg | 1 | 1 | 1 | 1 |

### Comment:

Only a very slow demulsification is observed when no demulsifier is added. The 4 assessment is unacceptable; a stable emulsion is formed.

The hydrophobins exhibit a very good demulsifying effect even when present in extremely small quantities. 0.01 ppm of hydrophobin is sufficient to lead to an acceptable result within 1 min. 1.45 mg of the commercially available demulsifier based on phenol resins have to be added to each kg of fuel in order to achieve the same effect as that achieved with 0.07 mg of hydrophobin/kg. Consequently, when hydrophobin is used, only approx. 1/20 of the quantity of a conventional demulsifier is required in order to achieve the same effect.

### Comparative Example 11

### Using Other Proteins as Additives in Fuels

Non-hydrophobin proteins were tested for use in fuels in analogy with example 10.

The experiments were carried out using bovine serum albumin (BSA) and casein. These proteins are commercially available. yaad as depicted in SEQ ID No. 15 and 16, i.e. the fusion partner on its own without being linked to a hydrophobin, was also used.

The respective protein was added, at a concentration of 0.07 mg/kg, to a commercially obtainable Eurosuper fuel (in accordance with EN 228) which already comprised 1000 mg of the abovementioned performance additive package A/kg. The fuel to which only A, and not protein, had been added served as the reference.

Emulsion tests were carried out in each case in accordance with DIN 51415, as described above.

TABLE 2

| | | 1 min. | 5 min. | 30 min. | 60 min. |
|---|---|---|---|---|---|
| 11-V3 | A | 4 | 4 | 2 | 1b |
| (comparative) | | | | | |
| 11-1 | A + 0.07 mg of | 2 | 1 | 1 | 1 |
| | BSA/kg | | | | |
| 11-2 | A + 0.07 mg of | 3 | 1 | 1 | 1 |
| | yaad/kg | | | | |
| 11-2 | A + 0.07 mg of | 3 | 1b | 1 | 1 |
| | casein/kg | | | | |

### Comment:

Without the addition of a demulsifier, the separation of the emulsion proceeds just as slowly as in example 10. The 4 assessment is unacceptable; a stable emulsion is formed. While the proteins which are used have a demulsifying effect, the rate of the demulsification is lower than when using hydrophobins.

### Example 12

### Using a Hydrophobin Concentrate Yaad-Xa-dewA-His as an Emulsion Breaker for Crude Oil

The experiment was carried out using a hydrophobin concentrate as described in Example 8 (SEQ ID NOS. 19 and 20).

In the experiments which were carried out, various amounts of hydrophobin concentrate were added to 50 ml of crude oil (sample ex Wintershall A G, Emlichheim, well 301; residual water content after using conventional demulsifiers, approx. 3%). The concentration of the hydrophoin in the crude oil was 1 ppm, 10 ppm and 40 ppm. After the homogenizing, the mixtures were centrifuged at 2000 rpm for 10 min. The results are given in Table 3.

TABLE 3

| Hydrophobin added | Free water phase | Emulsion phase |
|---|---|---|
| No addition | 0.4% | 2.4% |
| 1 ppm | 0.8% | 2.0% |
| 10 ppm | 2.4% | 0.4% |
| 40 ppm | 2.4% | 0.4% |

After 10 and 40 ppm of hydrophobin concentrate had been added, the free water phase formed the major component.

### Example 13

### Using a Hydrophobin Concentrate Yaad-Xa-dewA-His for Fractionating Polymers

The experiment was carried out using a hydrophobin concentrate as described in Example 8 (SEQ ID NOS. 19 and 20).

In each case 150 g of a polyacrylic acid in the form of a sodium salt (Sokalan® CP 10 S; M_{w} 4000 g/mol, in accordance with DE 199 50 941 A1) were initially introduced into two glass beakers after which 75 g of isopropanol were added in each case. The mixtures were stirred for 5 min, after which in each case 146 g of isopropanol/water (in a ratio of 1/1) were added and the mixtures were stirred for 5 min.

50 ppm of hydrophobin (1.64 m, 11.3 mg/ml) were added to glass beaker A and the mixture was stirred for 5 min. The hydrophobin produced white streaks in the clear solution, with the streaks then being completely dissolved after 5 min. 19.75 g of 50% NaOH were added to both glass beakers and the mixtures were stirred for 15 min.

A milky solution was formed immediately in the presence of the hydrophobin while a strongly opaque solution was formed in the absence of added hydrophobin. After a stirring time of 15 min, the contents of the glass beakers were in each case transferred to a 500 ml separating funnel, after which the funnels were shaken briefly and observed to determine the length of time taken for the phases to separate.

In the case of the sample comprising hydrophobin, a clear phase separation was seen after 10 min; in the absence of added hydrophobin, a foamy “intermediate layer” formed initially; that is a clear phase boundary was not formed. In the absence of added hydrophobin, a clear phase boundary was only formed after 40 minutes.

### Period of Separation Until a Sharp Phase Boundary Appeared:

with hydrophobin: 12 minutes
without hydrophobin: 40 minutes

### Example 14

### Comparative Example 15

### Use of a Hydrophobin Fusion (Yaad-Xa-dewA-His₆) and Bovine Serum Albumin (BSA) as Demulsifiers for an Oil-Water Emulsion at 55° C.

The experiment was carried out using a hydrophobin concentrate as described in example 8 (SEQ ID Nos. 19 and 20) as well as using a commercially available solution of bovine serum albumin (BSA).

The demulsifying ability was tested as follows:

The oil employed was a hydraulic oil.

40 ml of distilled water were initially introduced in a 100 ml measuring cylinder and the relevant protein was added in a quantity of 5 ppm based on the water or 2.5 ppm based on the total system. 40 ml of hydraulic oil were then added and the system was equilibrated at 55° C. in a water bath. The temperature equilibration time was 20 min. After that, the oil and the water were emulsified at 1500 rpm for 5 min using a blade mixer. This emulsifies the oil in the water phase. After that, the separation of the phases was observed. That which is given is in each case the quantity of the water phase, in ml, which has reseparated.

In one experimental series, the aqueous solutions of the two proteins were used unchanged. The results are depicted in graph 1.

In a second experimental series, the solutions of the two proteins were first of all adjusted, at RT, to pH 1 using HCl and then left at pH 1 for 24 h. After that, they were adjusted once again to pH 7 using NaOH. The results are depicted in graph

### Comment:

BSA only improves the rate of the demulsification of the oil-water emulsion to a slight extent as compared with a sample without demulsifier. On the other hand, a very marked acceleration in the demulsification is observed when hydrophobins are added.

1. The use of at least one hydrophobin for improving phase separation in compositions comprising at least two liquid phases.

2. The use according to claim 1, wherein the at least one hydrophobin is employed as a demulsifier.

3. The use according to claim 1 or 2, wherein the at least one hydrophobin is a hydrophobin fusion.

4. The use according to claim 3, wherein the hydrophobin fusion is at least one selected from the group of yaad-Xa-dewA-his (SEQ ID No: 20), yaad-Xa-rodA-his (SEQ ID No: 22) and yaad-Xa-basf1-his (SEQ ID No: 24), with yaad also being able to be a truncated fusion partner yaad′ having from 20 to 293 amino acids.

5. The use according to one of claims 1 to 4, wherein the composition comprising at least two liquid phases is selected from the group consisting of
compositions comprising oil and water,
compositions comprising a fuel or combustible and water,
reaction mixtures comprising at least two liquid phases.

6. The use according to one of claims 1 to 5, wherein the at least one hydrophobin is employed in a quantity of from 0.0001 to 1000 ppm, based on the total composition.

7. The use according to claim 6, wherein the composition is a crude oil-water composition and the at least one hydrophobin is employed in a quantity of from 1 to 800 ppm, based on the total composition.

8. The use according to claim 6, wherein the composition is a fuel/combustible-water composition and the at least one hydrophobin is employed in a quantity of from 0.001 to 10 ppm, based on the total composition.

9. The use according to one of claims 1 to 8, wherein at least one further compound which improves the phase separation is employed in addition to the at least one hydrophobin.

10. A method for separating at least two liquid phases in a composition comprising at least two liquid phases, comprising the addition of at least one hydrophobin to the composition.

11. The method according to claim 10, wherein the at least one hydrophobin is a hydrophobin fusion or a derivative thereof.

12. The method according to claim 11, wherein the hydrophobin fusion is at least one selected from the group of yaad-Xa-dewA-his (SEQ ID No: 20), yaad-Xa-rodA-his (SEQ ID No: 22) and yaad-Xa-basf1-his (SEQ ID No: 24), with yaad also being able to be a truncated fusion partner yaad' having from 20 to 293 amino acids.

13. The method according to one of claims 10 to 12, wherein the composition comprising at least two liquid phases is selected from the group consisting of
compositions comprising oil and water,
compositions comprising a fuel or combustible and water,
reaction mixtures comprising at least two liquid phases.

14. The method according to one of claims 10 to 13, wherein the at least one hydrophobin is employed in a quantity of from 0.0001 to 1000 ppm, based on the total composition.

15. The method according to claim 14, wherein the composition is a crude oil-water composition and the at least one hydrophobin is employed in a quantity of from 1 to 800 ppm, based on the total composition.

16. The method according to claim 14, wherein the composition is a fuel/combustible-water composition and the at least one hydrophobin is employed in a quantity of from 0.001 to 10 ppm, based on the total composition.

17. The method according to one of claims 10 to 16, wherein the method comprises increasing the temperature of the composition comprising at least two liquid phases before or after adding the at least one hydrophobin.

18. A formulation, comprising at least one compound selected from the group consisting of fuels, combustibles, crude oils or water-soluble or oil-soluble polymer solutions and at least one hydrophobin.

19. The formulation according to claim 18, wherein the hydrophobin is present in the formulation in a quantity of from 0.0001 to 1000 ppm, based on the total formulation.

20. The formulation according to claim 18 or 19, wherein the formulation comprises at least one fuel or combustible and the hydrophobin or the derivative thereof is present in the formulation in a quantity of from 0.001 to 0.5 ppm, based on the total formulation.

21. The formulation according to claim 20, wherein the fuel or combustible is a fuel which is selected from the group of gasolines, diesel fuels and turbine fuels.

22. The formulation according to one of claims 18 to 21, wherein the at least one protein is a hydrophobin fusion or a derivative thereof.

23. The formulation according to claim 22, wherein the hydrophobin fusion is at least one selected from the group of yaad-Xa-dewA-his (SEQ ID No: 20), yaad-Xa-rodA-his (SEQ ID No: 22) and yaad-Xa-basf1-his (SEQ ID No: 24), with yaad also being able to be a truncated fusion partner yaad′ having from 20 to 293 amino acids.

24. A method for separating at least two liquid phases in a composition comprising at least two liquid phases, comprising the addition of at least one hydrophobin to the composition.

25. The method according to claim 24, wherein at least one of the at least one hydrophobins is a hydrophobin fusion or a derivative thereof.

26. The method according to claim 25, wherein the at least one hydrophobin fusion or derivative thereof is selected from the group consisting of SEQ ID No: 20, SEQ ID No: 22 and SEQ ID No: 24.

27. The method according to claim 24, wherein the composition comprising at least two liquid phases is selected from the group consisting of compositions comprising oil and water, compositions comprising a fuel or combustible and water, and reaction mixtures comprising at least two liquid phases.

28. The method according to one of claim 24, wherein the at least one hydrophobin is employed in a quantity of from 0.0001 to 1000 ppm, based on the total composition.

29. The method according to claim 28, wherein the composition is a crude oil-water composition and the at least one hydrophobin is employed in a quantity of from 1 to 800 ppm, based on the total composition.

30. The method according to claim 28, wherein the composition is a fuel/combustible-water composition and the at least one hydrophobin is employed in a quantity of from 0.001 to 10 ppm, based on the total composition.

31. The method according to claim 24, wherein the method comprises increasing the temperature of the composition comprising at least two liquid phases before or after adding the at least one hydrophobin.

32. A formulation comprising at least one compound selected from the group consisting of fuels, combustibles, crude oils, water-soluble polymer solutions, and oil-soluble polymer solutions, and further comprising at least one hydrophobin, wherein the at least one hydrophobin is present in the formulation in a quantity of from 0.0001 to 1000 ppm, based on the total formulation.

33. The formulation according to claim 32, wherein the formulation comprises at least one fuel or combustible, and the at least one hydrophobin or a derivative thereof is present in the formulation in a quantity of from 0.001 to 0.5 ppm, based on the total formulation.

34. The formulation according to claim 33, wherein the fuel or combustible is selected from the group consisting of gasolines, diesel fuels and turbine fuels.

35. The formulation according to claim 32, wherein at least one of the at least one hydrophobins is a hydrophobin fusion protein.

36. The formulation according to claim 35, wherein at least one hydrophobin fusion protein is selected from the group consisting of SEQ ID No: 20, SEQ ID No: 22 and SEQ ID No: 24.

37. The method according to claim 24, further comprising the addition of at least one compound that is not a hydrophobin or hydrophobin fusion, and wherein the phase separation of the at least two liquid phases is improved over the phase separation achieved without the addition of the compound.


SEQUENCE LISTING (35 sequences)

SEQ ID NO: 1 - DNA, 405 bp, Aspergillus nidulans
  CDS (1)..(405): basf-dewA hydrophobin
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Aspergillus nidulans
  basf-dewA hydrophobin
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Aspergillus nidulans
  CDS (1)..(471): basf-rodA hydrophobin
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Aspergillus nidulans
  basf-rodA hydrophobin
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Artificial Sequence
  CDS (1)..(336): Chemically synthesized polynucleotide basf-hypA
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Artificial Sequence
  basf-hypA from chemically synthesized polynucleotide
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Artificial Sequence
  CDS (1)..(357): chemically synthesized polynucleotide basf-hypB
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Artificial Sequence
  basf-hypB from chemically synthesized polynucleotide
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Schyzophyllum commune
  CDS (1)..(408): basf-sc3 hydrophobin, cDNA template
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Schyzophyllum commune
  basf-sc3 hydrophobin, cDNA
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial Sequence
  CDS (1)..(483): chemically synthesized polynucleotide basf-BASF1
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial Sequence
  basf-BASF1 from chemically synthesized polynucleotide
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial Sequence
  CDS (1)..(465): chemically synthesized polynucleotide basf-BASF2
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial Sequence
  basf-BASF2 from chemically synthesized polynucleotide
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Bacillus subtilis
  CDS (1)..(882): basf-yaad yaaD
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Bacillus subtilis
  basf-yaad yaaD
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Bacillus subtilis
  CDS (1)..(591): basf-yaae yaaE with Gly insert at position 2
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Bacillus subtilis
  basf-yaae yaaE with Gly insert at position 2
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial Sequence
  CDS (1)..(1329): basf-yaad-Xa-dewA-his fusion of Bacillus subtilis yaaD and N-terminal factor Xa proteinase cleavage site and Aspergillus nidulans hydrophobin dewA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial Sequence
  basf-yaad-Xa-dewA-his fusion of Bacillus subtilis yaaD and N-terminal factor Xa proteinase cleavage site and Aspergillus nidulans hydrophobin dewA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial Sequence
  CDS (1)..(1395): basf-yaad-Xa-rodA-his fusion of Bacillus subtilis yaaD and N-terminal factor Xa proteinase cleavage site and Aspergillus nidulans hydrophobin rodA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial Sequence
  basf-yaad-Xa-rodA-his fusion of Bacillus subtilis yaaD and N-terminal factor Xa proteinase cleavage site and Aspergillus nidulans hydrophobin rodA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial Sequence
  CDS (1)..(1407): basf-yaad-Xa-BASF1-his fusion of Bacillus subtilis yaaD and N-terminal factor Xa proteinase cleavage site and artificial hydrophobin BASF1; BASF1 from chemically synthesized polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial Sequence
  basf-yaad-Xa-BASF1-his fusion of Bacillus subtilis yaaD and N-terminal factor Xa proteinase cleavage site and artificial hydrophobin BASF1; BASF1 from chemically synthesized polynucleotide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 28 bp, Artificial Sequence
  Chemically synthesized Hal570 primer
gcgcgcccatggctcaaacaggtactga

SEQ ID NO: 26 - DNA, 28 bp, Artificial Sequence
  Chemically synthesized Hal571 primer
gcagatctccagccgcgttcttgcatac

SEQ ID NO: 27 - DNA, 30 bp, Artificial Sequence
  Chemically synthesized Hal572 primer
ggccatgggattaacaataggtgtactagg

SEQ ID NO: 28 - DNA, 33 bp, Artificial Sequence
  Chemically synthesized Hal573 primer
gcagatcttacaagtgccttttgcttatattcc

SEQ ID NO: 29 - DNA, 38 bp, Artificial Sequence
  Chemically synthesized KaM416 primer
gcagcccatcagggatccctcagccttggtaccagcgc

SEQ ID NO: 30 - DNA, 50 bp, Artificial Sequence
  Chemically synthesized KaM417 primer
cccgtagctagtggatccattgaaggccgcatgaagttctccgtctccgc

SEQ ID NO: 31 - DNA, 45 bp, Artificial Sequence
  Chemically synthesized KaM434 primer
gctaagcggatccattgaaggccgcatgaagttctccattgctgc

SEQ ID NO: 32 - DNA, 30 bp, Artificial Sequence
  Chemically synthesized KaM435 primer
ccaatggggatccgaggatggagccaaggg

SEQ ID NO: 33 - DNA, 38 bp, Artificial Sequence
  Chemically synthesized KaM418 primer
ctgccattcaggggatcccatatggaggagggagacag

SEQ ID NO: 34 - DNA, 32 bp, Artificial Sequence
  Chemically synthesized KaM464 primer
cgttaaggatccgaggatgttgatgggggtgc

SEQ ID NO: 35 - DNA, 35 bp, Artificial Sequence
  Chemically synthesized KaM465 primer
gctaacagatctatgttcgcccgtctccccgtcgt